(19) United States
(12) Patent Application Publication
(10) Pub. No.: US 2019/0378082 A1
(43) Pub. Date: Dec. 12, 2019

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kosuke KOTAKE, Nagoya-shi (JP); Ryosuke TANIMURA, Toyota-shi (JP); Yuki ITO, Iwakura-shi (JP); Akira NISHIDA, Toyota-shi (JP); Zekai QIU, Nisshin-shi (JP); Kenichi HAGIYA, Nagoya-shi (JP); Naoki YAMAMURO, Nagoya-shi (JP)

(73) Assignee: TOYOTA JIDOSHA KABUSHIKI KAISHA, Toyota-shi (JP)

(21) Appl. No.: 16/435,599

(22) Filed: Jun. 10, 2019

(30) Foreign Application Priority Data
Jun. 8, 2018 (JP) 2018-110222

(51) Int. Cl. G06Q 10/08; G06Q 50/30

(52) U.S. Cl. CPC G06Q 10/083; G06Q 50/30

(57) ABSTRACT

The present disclosure provides a technique for enabling delivery of baggage of another user by utilizing a vehicle on which one user rides and travels. An information processing apparatus according to the present disclosure performs matching between a first user and a second user in the case where baggage of the second user can be delivered to a delivery destination by a vehicle when the first user travels to a traveling destination on the basis of first user information which is information regarding traveling by the vehicle of the first user and second user information which is information regarding delivery of the baggage of the second user.

### CROSS REFERENCE TO THE RELATED APPLICATION

This application claims the benefit of Japanese Patent Application No. 2018-110222, filed on Jun. 8, 2018, which is hereby incorporated by reference herein in its entirety.

### BACKGROUND

### Technical Field

The present disclosure relates to an information processing apparatus and an information processing method.

### Description of the Related Art

In recent years, a traveling form where a plurality of users share a ride on the same vehicle is widespread. Further, in such a traveling form, a technique for performing matching among a plurality of users has been developed.

Further, Patent document 1 discloses a technique for determining whether or not persons who possess respective terminals share a ride on the same vehicle.

### CITATION LIST

### Patent Document

[Patent document 1] Japanese Patent Laid-Open No. 2011-237842

### SUMMARY

As a form in which a plurality of users utilize the same vehicle, there can be a form other than a form in which the plurality of users share a ride on the vehicle. The present disclosure is directed to providing a technique for enabling delivery of baggage of another user by utilizing a vehicle on which one user rides and travels.

An information processing apparatus according to a first aspect of the present disclosure includes a controller that, on the basis of first user information which is information regarding traveling by a vehicle of a first user who plans to travel to a traveling destination by the vehicle and second user information which is information regarding delivery of baggage of a second user who desires to deliver the baggage to a delivery destination, performs matching between the first user and the second user in a case where it is determined that a predetermined condition is satisfied, the predetermined condition being a condition that the baggage of the second user can be delivered to the delivery destination by the vehicle when the first user travels to the traveling destination.

An information processing method according to a second aspect of the present disclosure includes a step of acquiring first user information which is information regarding traveling by a vehicle of a first user who plans to travel to a traveling destination by the vehicle, and second user information which is information regarding delivery of baggage of a second user who desires to deliver the baggage to a delivery destination,

a step of determining on the basis of the first user information and the second user information whether or not a predetermined condition is satisfied, the predetermined condition being a condition that the baggage of the second user can be delivered to the delivery destination by the vehicle when the first user travels to the traveling destination, and

a step of performing matching between the first user and the second user in the case where it is determined that the predetermined condition is satisfied.

A third aspect of the present disclosure is a non-transitory storage medium stored with a program for causing a computer to execute the information processing method, wherein the information processing method comprising:

a step of acquiring first user information which is information regarding traveling by a vehicle of a first user who plans to travel to a traveling destination by the vehicle, and second user information which is information regarding delivery of baggage of a second user who desires to deliver the baggage to a delivery destination;

a step of determining based on the first user information and the second user information whether or not a predetermined condition is satisfied, the predetermined condition being a condition that the baggage of the second user can be delivered to the delivery destination by the vehicle when the first user travels to the traveling destination; and

a step of performing matching between the first user and the second user in a case where it is determined that the predetermined condition is satisfied.

According to the present disclosure, it is possible to deliver baggage of another user by utilizing a vehicle on which one user rides and travels.

### BRIEF DESCRIPTION OF THE DRAWINGS

FIG. 1 is a diagram illustrating a schematic configuration of a matching system;

FIG. 2 is a block diagram schematically illustrating an example of each configuration of a first user terminal, a second user terminal and a management server according to a first embodiment;

FIG. 3 is a diagram illustrating an example of a table configuration of first user information;

FIG. 4 is a diagram illustrating an example of a table configuration of second user information;

FIG. 5 is a flowchart illustrating flow of matching processing;

FIG. 6 is a block diagram schematically illustrating an example of each configuration of a first user terminal, a second user terminal and a management server according to a second embodiment;

FIG. 7 is a diagram illustrating an example of a table structure of handing information; and

FIG. 8 is a flowchart illustrating flow of setting processing.

### DESCRIPTION OF THE EMBODIMENTS

An information processing apparatus according to a first aspect of the present disclosure may include a controller that performs matching between a first user and a second user on the basis of first user information regarding the first user and second user information regarding the second user. Here, the first user is a user who plans to travel to a traveling destination by a vehicle. Note that the traveling destination is a traveling destination of the first user. Then, the first user information is information regarding traveling by the vehicle of the first user. Further, the second user is a user who desires to deliver baggage to a delivery destination. Note that the delivery destination is a delivery destination of the baggage of the second user. Then, the second user information is information regarding delivery of the baggage of the second user.

When the first user rides on the vehicle and travels, if there is room in load capacity of baggage in the vehicle, it is possible to load baggage of another person on the vehicle. However, in the case where the baggage of the other person is loaded on the vehicle of the first user, the first user needs to be able to deliver the baggage of the other person to a delivery destination desired by the other person while the first user travels to a traveling destination of the first user by the vehicle.

Therefore, in the information processing apparatus according to the first aspect of the present disclosure, the controller may determine whether or not predetermined conditions are satisfied on the basis of the first user information and the second user information, the predetermined conditions being conditions that the baggage of the second user can be delivered to the delivery destination by the vehicle when the first user travels to the traveling destination. Then, in the case where it is determined that the predetermined conditions are satisfied, the controller may perform matching between the first user and the second user. Note that “performing matching between the first user and the second user” means paring between the first user and the second user. Further, the second user is merely a user who desires to deliver the baggage, and is not a passenger who rides on the vehicle when the first user travels to the traveling destination.

By matching being performed as described above, the second user can deliver the baggage by utilizing the vehicle on which the first user rides and travels.

Further, the first user information may include information regarding a traveling destination, information regarding a starting point of traveling by the vehicle, information regarding scheduled traveling time and information regarding empty space in predetermined space in which baggage is to be loaded in the vehicle. Here, the “information regarding the traveling destination” is information from which a location of the traveling destination of the first user can be specified. Further, the “information regarding a starting point of traveling by the vehicle” is information from which a location of the starting point when the first user travels to the traveling destination by the vehicle can be specified. Still further, the “information regarding scheduled traveling time” is information from which scheduled time at which the first user travels to the traveling destination can be specified.

Further, the “predetermined space in which baggage is to be loaded” is space such as a luggage room, in which baggage can be loaded in the vehicle. Here, when the first user travels to the traveling destination by the vehicle, there is a case where there is still empty space in the predetermined space in which baggage is to be loaded even if baggage of the first user himself/herself and/or baggage of a passenger of the vehicle are loaded in the predetermined space in which baggage is to be loaded in the vehicle. The “information regarding empty space in predetermined space in which baggage is to be loaded in the vehicle” is information from which volume of empty space in such a case in the predetermined space in which baggage is to be loaded in the vehicle on which the first user rides can be specified.

Further, the second user information may include information regarding a delivery destination, information regarding a starting point of delivery of the baggage, information regarding desired delivery time and information regarding a volume of the baggage. Here, the “information regarding the delivery destination” is information from which a location of the delivery destination of the second user can be specified. Further, the “information regarding a starting point of delivery of the baggage” is information from which a location of the starting point when the second user delivers the baggage to the delivery destination can be specified. Still further, the “information regarding the desired delivery time” is information from which time at which the second user desires to deliver the baggage to the delivery destination can be specified.

Further, the “information regarding a volume of the baggage” is information from which a volume of the baggage which the second user desires to deliver to the delivery destination can be specified. Here, in the case where there are a plurality of pieces of baggage which the second user desires to deliver to the delivery destination, the “information regarding a volume of the baggage” is information regarding a volume of all the plurality of pieces of baggage.

As a result of the first user information and the second user information including the information as described above, it is possible to determine whether or not the baggage of the second user can be loaded on the vehicle on which the first user rides, and whether or not the first user can deliver the baggage of the second user to the delivery destination while the first user travels to the traveling destination. That is, it is possible to determine whether or not the predetermined conditions are satisfied on the basis of the first user information and the second user information.

Specific embodiments of the present disclosure will be described below on the basis of the drawings. The technical scope of the disclosure is not limited to sizes, materials, shapes, relative arrangement, or the like, of components described in the present embodiment unless otherwise noted.

### First Embodiment

(Outline of System)

Embodiments of the present disclosure will be described below using an example in the case where the present disclosure is applied to a matching system for performing matching between a user who plans to travel to a golf course by a vehicle (hereinafter, referred to as a “first user”) and a user who desires to deliver a golf bag (baggage) to the golf course (hereinafter, referred to as a “second user”). Note that the first user does not necessarily have to be a driver of the vehicle, and may be a user who plans to travel to the golf course by riding on the vehicle which the driver drives.

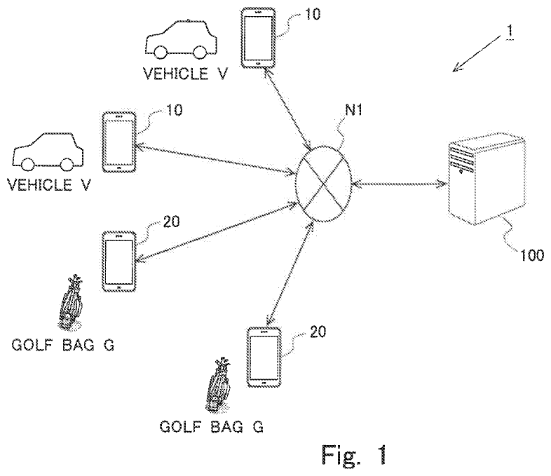

FIG. 1 is a diagram illustrating a schematic configuration of the matching system according to the present embodiment. A matching system 1 includes a first user terminal 10 carried by each first user, a second user terminal 20 carried by each second user, and a management server 100. Here, the first user is a user who plans to travel to a desired golf course which is a traveling destination of each user by a vehicle V. Further, the second user is a user who desires to deliver a golf bag G to a desired golf course which is a delivery destination of each user. Note that the second user is a user who does not desire to travel to the golf course along with the golf bag G of the second user, and desires to merely deliver the golf bag G (including a user who plans to travel to the golf course using means different from delivery of the golf bag G). Further, there are the first user terminals 10 of the number corresponding to the number of the first users who utilize the matching system 1. Further, there are the second user terminals 20 of the number corresponding to the number of the second users who utilize the matching system 1.

In the matching system 1, the respective first user terminals 10, the respective second user terminals 20 and the management server 100 are connected to each other via a network N1. As the network N1, for example, a WAN (Wide Area Network) which is a global public communication network such as the Internet, or other communication networks may be employed. Further, the network N1 may include a telecommunication network such as a mobile phone and a wireless communication network such as WiFi.

Predetermined application for utilizing service by the matching system 1 is installed at each first user terminal 10 and each second user terminal 20. Then, each first user can register information regarding traveling to the golf course (traveling destination) by the vehicle V, which is planned by each first user (hereinafter, referred to as “first user information”) in the management server 100 by activating the predetermined application at the first user terminal 10. Further, each second user can register information regarding delivery of the golf bag G to the golf course (delivery destination) which each second user desires (hereinafter, referred to as “second user information”) in the management server 100 by activating the predetermined application at the second user terminal 20. Note that details of the first user information and the second user information will be described later.

Further, the management server 100 is a server which manages the registered first user information and second user information. Further, the management server 100 performs matching between the first user and the second user on the basis of the first user information and the second user information. Note that, in the present embodiment, the management server 100 corresponds to an “information processing apparatus” according to a first aspect of the present disclosure.

Here, when the first user travels to the golf course by the vehicle V, there is a case where, even if baggage of the first user (including a golf bag of the first user, a golf bag of a passenger in the vehicle V, or the like) is loaded in a luggage room of the vehicle V, there occurs empty space of a volume which is enough for golf bags of others to be additionally loaded, in the luggage room. In such a case, if there is the second user who desires to deliver the golf bag G to the golf course which is the same as the traveling destination of the first user, it is possible to additionally load the golf bag G of the second user in the luggage room of the vehicle V and deliver the golf bag G while the first user travels to the golf course by the vehicle V.

Therefore, the management server 100 determines whether or not it is possible to deliver the golf bag G of the second user to the delivery destination by the vehicle V when the first user travels to the traveling destination, and, if it is possible to deliver the golf bag G, performs matching between the first user and the second user. Note that the management server 100 merely performs matching between the first user who plans to travel by the vehicle V and the second user who desires to deliver the golf bag G, and does not perform matching between the first user and a person who shares a ride on the vehicle V of the first user.

(System Configuration)

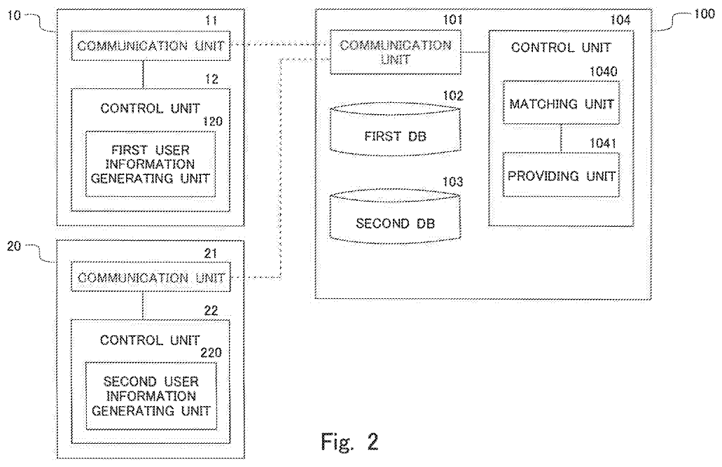

FIG. 2 is a block diagram schematically illustrating an example of each configuration of the first user terminal 10, the second user terminal 20 and the management server 100 constituting the matching system 1 according to the present embodiment. Hardware configurations and functional configurations of the first user terminal 10, the second user terminal 20 and the management server 100 will be described below on the basis of FIG. 2.

(First User Terminal, Second User Terminal)

The first user terminal 10 and the second user terminal 20 are small computers such as, for example, smartphones, tablet computers, mobile computers, wearable computers, wireless storages, mobile phones and handy terminals. Further, the first user terminal 10 and the second user terminal 20 may be personal computers (PCs) which are connected to the management server 100 via the network N1.

The first user terminal 10 includes a communication unit 11 and a control unit 12. The second user terminal 20 includes a communication unit 21 and a control unit 22. The communication unit 11 is communication means for connecting the first user terminal 10 to the network N1. Further, the communication unit 21 is communication means for connecting the second user terminal 20 to the network N1. The communication unit 11 and the communication unit 21 can perform communication with other apparatuses including the management server 100 via the network N1 by utilizing mobile communication service such as, for example, 3G (3rd Generation) and LTE (Long Term Evolution).

Further, the control unit 12 is a computer which controls the first user terminal 10. Further, the control unit 22 is a computer which controls the second user terminal 20. The control unit 12 and the control unit 22 are configured with, for example, microcomputers, and implement various kinds of functions which will be described later by executing programs stored in storage means (such as a ROM) by the CPU.

At the first user terminal 10, the control unit 12 includes a functional unit which transmits the first user information to the management server 100 via the communication unit 11. Further, the control unit 12 includes a functional unit which receives matching information which is information regarding a matching result from the management server 100 via the communication unit 11. Still further, the control unit 12 includes a functional unit which outputs the matching information received from the management server 100 to an input/output unit (for example, a touch panel display) provided at the first user terminal 10.

Further, the control unit 12 includes a first user information generating unit 120 which generates first user information as a functional unit. The first user information generating unit 120 generates first user information on the basis of input operation performed by the first user on the input/output unit of the first user terminal 10 after activating the above-described predetermined application.

Here, the first user information includes information regarding the traveling destination which is the golf course to which the first user plans to travel by the vehicle V, a home location of the first user which becomes a starting point of traveling of the first user to the traveling destination by the vehicle V, and traveling date and time which is time at which the first user plans to travel to the traveling destination by the vehicle V. Further, the first user information also includes information regarding empty space of the luggage room of the vehicle V when the first user travels to the traveling destination by the vehicle V (hereinafter, referred to as “empty space information”). That is, when the first user travels to the traveling destination by the vehicle V, there is a case where, even in a state where baggage of the first user himself/herself (for example, a golf bag of the first user himself/herself) and/or baggage of a passenger in the vehicle V (for example, a golf bag of the passenger) is loaded in the luggage room of the vehicle V, there occurs empty space in the luggage room of the vehicle V. Then, if there is a sufficient volume of empty space in the luggage room of the vehicle V at this time, the empty space becomes space in which the golf bag G of the second user can be additionally loaded. The empty space information is information regarding a volume of the empty space in the luggage room of the vehicle V at this time. Note that, it is assumed in the present embodiment that this empty space information is indicated with the number of golf bags which can be additionally loaded.

Note that, in the present embodiment, the luggage room of the vehicle V corresponds to “predetermined space in which baggage is to be loaded” according to the first aspect of the present disclosure. However, the “predetermined space in which baggage is to be loaded” according to the first aspect of the present disclosure may be space other than the luggage room (for example, part of space within a passenger compartment) if the space is space in which baggage can be loaded in the vehicle.

Meanwhile, at the second user terminal 20, the control unit 22 includes a functional unit which transmits the second user information to the management server 100 via the communication unit 21. Further, the control unit 22 includes a functional unit which receives matching information which is information regarding a matching result from the management server 100 via the communication unit 21. Still further, the control unit 22 includes a functional unit which outputs the matching information received from the management server 100 to an input/output unit (for example, a touch panel display) provided at the second user terminal 20.

Further, the control unit 12 includes a second user information generating unit 220 which generates the second user information as a functional unit. The second user information generating unit 220 generates the second user information on the basis of input operation performed by the second user on the input/output unit of the second user terminal 20 after activating the above-described predetermined application.

Here, the second user information includes information regarding the delivery destination which is the golf course to which the second user desires to deliver the golf bag G, a home location of the second user, which becomes a starting point of delivery of the golf bag G to the delivery destination of the second user, and delivery date and time which is time at which the second user desires to deliver the golf bag G to the delivery destination. Further, the second user information also includes information regarding the number of the golf bags G which the second user desires to deliver to the delivery destination (hereinafter, referred to as “delivery bag number information”).

(Management Server)

The management server 100 will be described next. The management server 100 is configured with typical computers. That is, the management server 100 is a computer including a processor such as a CPU and a DSP, a main storage unit such as a read only memory (ROM) and a random access memory (RAM), and an auxiliary storage unit such as an EPROM, a hard disk drive (HDD) and a removable medium. Note that the removable medium is, for example, a flash memory such as a USB memory and an SD card or a disk recording medium such as a CD-ROM, a DVD disk and a Blu-ray disk. In the auxiliary storage unit, an operating system (OS), various kinds of programs, various kinds of tables, or the like, are stored, and, by executing the programs stored therein being loaded to a work area of the main storage unit and executed, and each component, or the like, being controlled through execution of the programs, it is possible to implement each functional unit which accomplishes predetermined purposes, which will be described later. However, part or all of the functional units may be implemented with hardware circuits such as ASICs and FPGAs. Note that the management server 100 may be configured with a single computer or may be configured with a plurality of computers which coordinate with each other.

The management server 100 receives the first user information from each first user terminal 10 by way of the network N1. Further, the management server 100 receives the second user information from each second user terminal 20 by way of the network N1. Further, the management server 100 registers the received first user information regarding each first user and the received second user information regarding each second user in a database which will be described later. Still further, the management server 100 transmits matching information to each first user terminal 10 and each second user terminal 20.

The management server 100 includes a communication unit 101, a first database (first DB) 102, a second database (second DB) 103 and a control unit 104. The communication unit 101 is communication means for connecting the management server 100 to the network N1. The communication unit 101 includes, for example, a LAN (Local Area Network) interface board and wireless communication circuits for wireless communication.

The first DB 102 is a database in which the first user information regarding the respective first users is stored. Specifically, in the first DB 102, the first user information received from the respective first user terminals 10 is stored in association with the first users. Further, the second DB 103 is a database in which the second user information regarding the respective second users is stored. Specifically, in the second DB 103, the second user information received from the respective second user terminals 20 is stored in association with the second users. The first DB 102 and the second DB 103 are constructed by a program of a database management system (DBMS) to be executed by a processor managing data stored in the above-described auxiliary storage unit. The first DB 102 and the second DB 103 are, for example, relational databases.

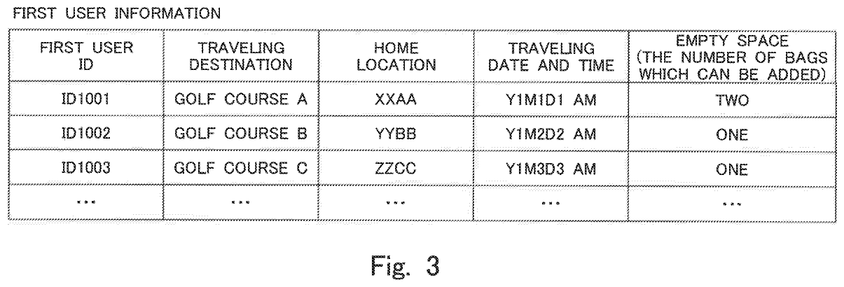

Here, a table configuration of the first user information stored in the first DB 102 will be described on the basis of FIG. 3. FIG. 3 is a diagram illustrating an example of the table configuration of the first user information stored in the first DB 102. This first user information table has a first user ID field, a traveling destination field, a home location field, a traveling date and time field and an empty space field.

In the first user ID field, a first user ID which is identification information for specifying the first user is input. Further, in the traveling destination field, information regarding the traveling destination of the first user included in the first user information received from the first user terminal 10 is input. Specifically, name of the golf course which is the traveling destination of the first user is input. However, the information to be input to the traveling destination field is not limited to the name of the golf course, and it is sufficient if the information to be input to the traveling destination field is information from which a location of the golf course which is the traveling destination of the first user can be specified.

Further, in the home location field, information regarding a home location of the first user included in the first user information received from the first user terminal 10 is input. Specifically, address information of the home of the first user is input. However, the information to be input to the home location field is not limited to the address information of the home, and it is sufficient if the information to be input to the home location field is information from which the home location of the first user can be specified. Further, in the traveling date and time field, information regarding traveling date and time of the first user included in the first user information received from the first user terminal 10 is input. Specifically, a date and a time slot at which the first user plans to play golf at the golf course which is the traveling destination are input. However, the information to be input to the traveling date and time field is not limited to the date and the time slot at which the first user plans to play golf, and it is sufficient if the information to be input to the traveling date and time field is information from which the traveling date and time of the first user can be specified. Further, in the empty space field, the empty space information included in the first user information received from the first user terminal 10 is input. That is, the number of golf bags which can be additionally loaded in the luggage room of the vehicle V when the first user travels to the traveling destination by the vehicle V is input.

Note that, in the present embodiment, the “information regarding the traveling destination”, the “information regarding the home location” and the “information regarding the traveling date and time” to be input to the first user information table respectively correspond to “information regarding a traveling destination”, “information regarding a starting point of traveling by the vehicle” and “information regarding scheduled traveling time” of the first user according to the first aspect of the present disclosure. However, the “information regarding a starting point of traveling by the vehicle” according to the first aspect of the present disclosure is not limited to the “information regarding the home location”. For example, in the case where the first user plans to travel from an office of the first user to the traveling destination by the vehicle V, information regarding a location of the office corresponds to the “information regarding a starting point of traveling by the vehicle”.

Further, in the present embodiment, the “empty space information” to be input to the first user information table corresponds to the “information regarding empty space in predetermined space in which baggage is to be loaded in the vehicle” of the first user according to the first aspect of the present disclosure. However, the “information regarding empty space in predetermined space in which baggage is to be loaded in the vehicle” according to the first aspect of the present disclosure is not limited to information indicated with the number of pieces of baggage which can be additionally loaded in the empty space in the predetermined space in which baggage is to be loaded. For example, the “information regarding empty space in predetermined space in which baggage is to be loaded in the vehicle” may include information regarding a type of baggage from which a volume of baggage which can be additionally loaded in the empty space in the predetermined space in which baggage is to be loaded can be specified to some extent.

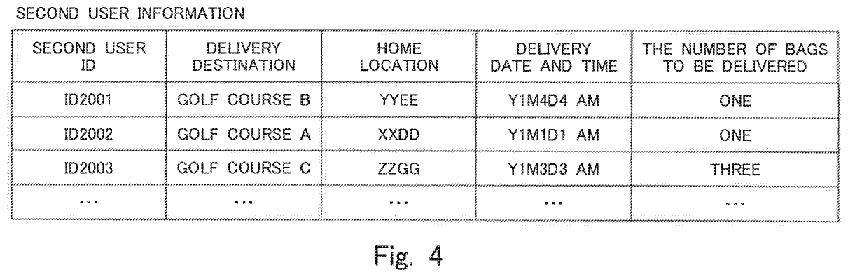

The table configuration of the second user information stored in the second DB 103 will be described next on the basis of FIG. 4. FIG. 4 is a diagram illustrating an example of the table configuration of the second user information stored in the second DB 103. This second user information table has a second user ID field, a delivery destination field, a home location field, a delivery date and time field and a delivery bag number field.

In the second user ID field, a second user ID which is identification information for specifying the second user is input. Further, in the delivery destination field, information regarding the delivery destination of the second user included in the second user information received from the second user terminal 20 is input. Specifically, name of the golf course which is the delivery destination of the second user is input. However, the information to be input to the delivery destination field is not limited to name of the golf course, and it is sufficient if the information to be input to the delivery destination field is information from which a location of the golf course which is the delivery destination of the second user can be specified.

Further, in the home location field, information regarding a home location of the second user included in the second user information received from the second user terminal 20 is input. Specifically, address information of the home of the second user is input. However, the information to be input to the home location field is not limited to the address information of the home, and it is sufficient if the information to be input to the home location field is information from which the home location of the second user can be specified. Further, in the delivery date and time field, information regarding delivery date and time of the second user included in the second user information received from the second user terminal 20 is input. Specifically, a date and a time slot at which the second user desires to deliver the golf bag G to the golf course which is the delivery destination are input. However, the information to be input to the delivery date and time field is not limited to the date and the time slot at which the second user desires to deliver the golf bag G, and it is sufficient if the information to be input to the delivery date and time field is information from which the delivery date and time of the second user can be specified. Further, in the delivery bag number field, the delivery bag number information included in the second user information received from the second user terminal 20 is input.

Note that, in the present embodiment, the “information regarding the delivery destination”, the “information regarding the home location” and the “information regarding the delivery date and time” to be input to the second user information table respectively correspond to the “information regarding a delivery destination”, the “information regarding a starting point of delivery of baggage” and the “information regarding desired delivery time” of the second user according to the first aspect of the present disclosure. However, the “information regarding a starting point of delivery of baggage” according to the first aspect of the present disclosure is not limited to the “information regarding the home location”. For example, in the case where the second user desires to deliver the golf bag G from accommodation of the second user to the delivery destination, information regarding a location of the accommodation corresponds to the “information regarding a starting point of delivery of baggage”.

Further, in the present embodiment, the delivery bag number information can be regarded as information regarding a volume of all the golf bags G which the second user desires to deliver to the delivery destination. That is, in the present embodiment, the “delivery bag number information” to be input to the second user information table corresponds to the “information regarding a volume of the baggage” of the second user according to the first aspect of the present disclosure. However, the “information regarding a volume of the baggage” according to the first aspect of the present disclosure is not limited to the number of pieces of baggage which the second user desires to deliver to the delivery destination. For example, the “information regarding a volume of baggage” may include information regarding a type of baggage from which a volume of baggage which the second user desires to deliver to the delivery destination can be specified to some extent.

The control unit 104 performs information management processing such as registration of the first user information in the first DB 102 and registration of the second user information in the second DB 103. Further, the control unit 104 executes processing for performing matching between the first user and the second user, and processing for providing a matching result to the first user and the second user. The control unit 104 includes a matching unit 1040 and a providing unit 1041 as functional units for executing these kinds of processing. Functions served by the respective functional units will be described below.

The matching unit 1040 executes matching processing on the basis of the first user information and the second user information. Here, the matching processing is processing for performing matching between the first user and the second user so that the golf bag G of the second user can be delivered to the delivery destination by the vehicle V when the first user travels to the traveling destination. Further, in the matching processing, matching information is generated on the basis of the matching result. This matching information includes information regarding whether or not matching can be achieved. Further, in the case where matching between the first user and the second user is achieved in the matching processing, matching information including personal information (such as, for example, name, phone number and email address) regarding a matching partner is generated. Note that details of the matching processing will be described later.

The providing unit 1041 transmits the matching information generated at the matching unit 1040 to the first user terminal 10 of the first user and the second user terminal 20 of the second user via the communication unit 101. By this means, personal information regarding the matching partner is provided to the first user and the second user between whom matching is achieved. By this means, the first user and the second user between whom matching is achieved can make contact with each other.

(Matching Processing)

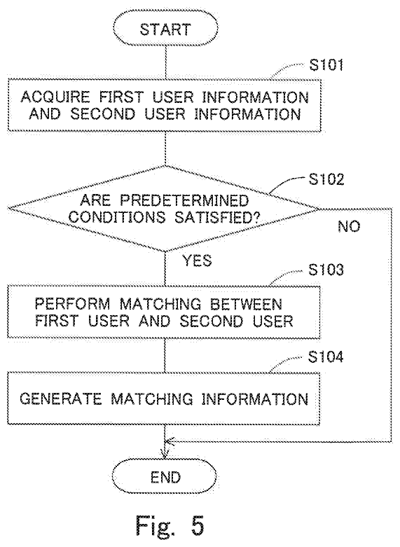

Details of the matching processing performed at the matching unit 1040 of the control unit 104 will be described next on the basis of the flowchart illustrated in FIG. 5. Here, the matching processing is performed by being checked respective pieces of the first user information stored in the first DB 102 and respective pieces of the second user information stored in the second DB 103. However, FIG. 5 illustrates processing to be performed on a pair of one piece of the first user information and one piece of the second user information. Therefore, the matching unit 1040 performs the processing illustrated in FIG. 5 on each pair of the respective pieces of the first user information stored in the first DB 102 and the respective pieces of the second user information stored in the second DB 103.

Further, it is assumed here that reception of the first user information from the first user terminal 10 of each first user who utilizes the matching system, and reception of the second user information from the second user terminal 20 of each second user who utilizes the matching system are completed, and a sufficient amount of information (the first user information and the second user information) is stored in the first DB 102 and the second DB 103.

In the flow illustrated in FIG. 5, first, in S101, one piece of the first user information among a plurality of pieces of the first user information stored in the first DB 102 and one piece of the second user information among a plurality of pieces of the second user information stored in the second DB 103 are acquired. Then, in S102, it is determined on the basis of the first user information and the second user information acquired in S101 whether or not predetermined conditions are satisfied that the golf bag G of the second user corresponding to the second user information can be delivered to the delivery destination by the vehicle V when the first user corresponding to the first user information travels to the traveling destination.

Here, the “predetermined conditions” need to be conditions that the golf bag G of the second user can be loaded on the vehicle V on which the first user rides, and the golf bag G of the second user can be delivered to the delivery destination while the first user travels to the traveling destination. Therefore, in the present embodiment, the following conditions (1) to (4) are determined as the “predetermined conditions”.

(1) The traveling destination in the first user information is the same as the delivery destination in the second user information.

(2) The home location in the first user information and the home location in the second user information are within a predetermined range (for example, within the same municipality).

(3) The traveling date and time in the first user information is the same as the delivery date and time in the second user information.

(4) The number of bags to be delivered in the second user information is equal to or smaller than the number of golf bags which can be additionally loaded in the luggage room of the vehicle V, which is indicated in the first user information as the empty space information.

Here, (1) if the traveling destination in the first user information is the same as the delivery destination in the second user information, if the vehicle V on which the first user rides arrives at the traveling destination, the golf bag G of the second user loaded on the vehicle V is delivered to the delivery destination. Further, (2) if the home location in the first user information and the home location in the second user information are within the predetermined range, it is possible to relatively easily hand the golf bag G of the second user between the first user and the second user. Further, (3) if the traveling date and time in the first user information is the same as the delivery date and time in the second user information, by the first user traveling by the vehicle V at the traveling date and time, the golf bag of the second user loaded on the vehicle V is delivered at the desired date and time. Still further (4) if the number of bags to be delivered in the second user information is equal to or smaller than the number of golf bags which can be additionally loaded in the luggage room of the vehicle V, which is indicated in the first user information as the empty space information, all the golf bags which the second user desires to deliver can be additionally loaded in the luggage room of the vehicle V on which the first user rides.

Therefore, in the case where all the above-described conditions (1) to (4) are satisfied in the first user information and the second user information acquired in S101, it is determined in S102 that the predetermined conditions are satisfied. Meanwhile, in the case where one of the above-described conditions (1) to (4) is not satisfied in the first user information and the second user information acquired in S101, it is determined in S102 that the predetermined conditions are not satisfied.

In the case where it is determined in S102 that the predetermined conditions are not satisfied, it can be judged that it is impossible to achieve matching between the first user and the second user corresponding to the first user information and the second user information acquired in S101 this time.

Meanwhile, in the case where it is determined in S102 that the predetermined conditions are satisfied, then, in S103, matching is achieved between the first user and the second user corresponding to the first user information and the second user information acquired in S101 this time. Then, in S104, matching information to be transmitted to the terminals 10 and 20 of the first user and the second user between whom matching is achieved in S103 is generated. At this time, the matching information to be transmitted to the first user terminal 10 is generated as information including personal information of the second user. Meanwhile, the matching information to be transmitted to the second user terminal 20 is generated as information including personal information of the first user.

Note that, in the present embodiment, the management server 100 may include a personal information database in which personal information of the respective users who utilize the matching system 1 is stored. In this case, the matching information as described above can be generated by being extracted the personal information of the first user and the second user between whom matching is achieved in S103 from the personal information database.

Further, there is a case where it is impossible to obtain a positive determination result in S102 even if the processing illustrated in FIG. 5 is repeatedly executed while the second user information is changed for one piece of the first user information. For the first user corresponding to the first user information for which the above-described predetermined conditions are not satisfied even if the first user information is paired with any of the plurality of pieces of the second user information registered in the second DB 103 in this manner, it can be judged that there is no second user with whom matching can be achieved. In a similar manner, there is a case where it is impossible to obtain a positive determination result in S102 even if the processing illustrated in FIG. 5 is repeatedly executed while the first user information is changed for one piece of the second user information. For the second user corresponding to the second user information for which the above-described predetermined conditions are not satisfied even if the second user information is paired with any of the plurality of pieces of the first user information registered in the first DB 102, it can be judged that there is no first user with whom matching can be achieved. The matching unit 1040 generates information indicating that matching is not achieved as the matching information to be provided to such a first user and a second user for whom there is no matching partner.

As described above, in the present embodiment, in the case where the golf bag G of the second user can be delivered to the delivery destination by the vehicle V when the first user travels to the traveling destination, matching is achieved between the first user and the second user. Therefore, the second user can deliver the golf bag G by utilizing the vehicle V on which the first user rides and travels.

### Modified Example

In the above-described embodiment, the above-described conditions (1) to (4) are determined as the “predetermined conditions” in the matching processing. However, the “predetermined conditions” are not limited to the above-described conditions (1) to (4).

For example, even if the traveling destination of the first user is not the same as the delivery destination of the second user, if the home location and the delivery destination of the second user exist on a traveling route from the home location of the first user to the traveling destination of the first user, it is possible to deliver the golf bag G of the second user to the delivery destination while the first user travels to the traveling destination. Therefore, the control unit 104 may derive the traveling route by the vehicle V of the first user on the basis of the information regarding the home location and the information regarding the traveling destination in the first user information. Then, in place of the above-described conditions (1) and (2), a condition that the home location and the delivery destination in the second user information exist on the derived traveling route of the first user may be included in the “predetermined conditions” in the matching processing.

Further, if the golf bag G of the second user is delivered to the delivery destination before the delivery date and time of the second user, the golf bag G exists at the delivery destination at the delivery date and time. Therefore, in place of the above-described condition (4), a condition that the traveling date and time of the first user is the same as or before the delivery date and time of the second user may be included in the “predetermined conditions” in the matching processing.

### Second Embodiment

In the present embodiment, in the case where matching is achieved between the first user and the second user through matching processing similar to that in the first embodiment, a location and time for handing the golf bag G between the first user and the second user between whom matching is achieved are further set.

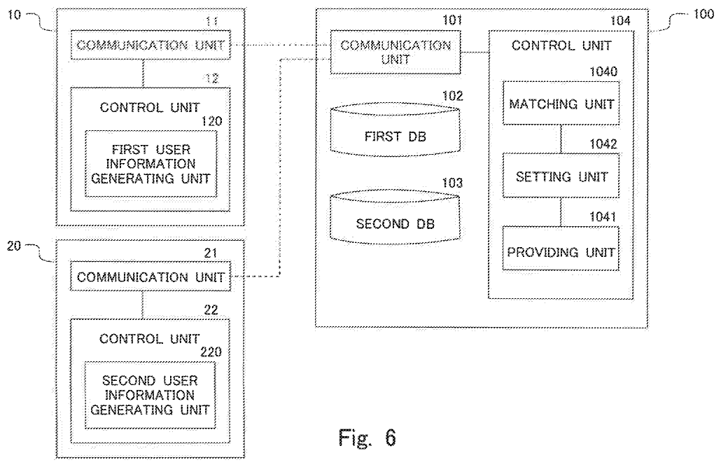

FIG. 6 is a block diagram schematically illustrating an example of each configuration of the first user terminal 10, the second user terminal 20 and the management server 100 which constitute the matching system 1 according to the present embodiment. As illustrated in FIG. 6, in the present embodiment, the configuration is different from the configuration according to the first embodiment in that the control unit 104 of the management server 100 includes a setting unit 1042 in addition to the matching unit 1040 and the providing unit 1041. Functions served by the setting unit 1042 at the control unit 104 of the management server 100 will be described below.

As described above, in the matching processing performed at the matching unit 1040, in the case where the golf bag G of the second user can be delivered to the delivery destination by the vehicle V when the first user travels to the traveling destination, matching is achieved between the first user and the second user. Here, actually, in order to deliver the golf bag G of the second user by the vehicle V of the first user, the golf bag G needs to be handed between the first user and the second user between whom matching is achieved.

Therefore, in the present embodiment, the setting unit 1042 executes setting processing of setting a location (hereinafter, referred to as a “handing location”) and a date and time (hereinafter, referred to as “handing date and time”) for handing the golf bag G between the first user and the second user between whom matching is achieved. In this setting processing, the handing location and the handing date and time are set on the basis of the first user information and the second user information. Further, in the setting processing, handing information which is information regarding the handing location and the handing date and time is generated.

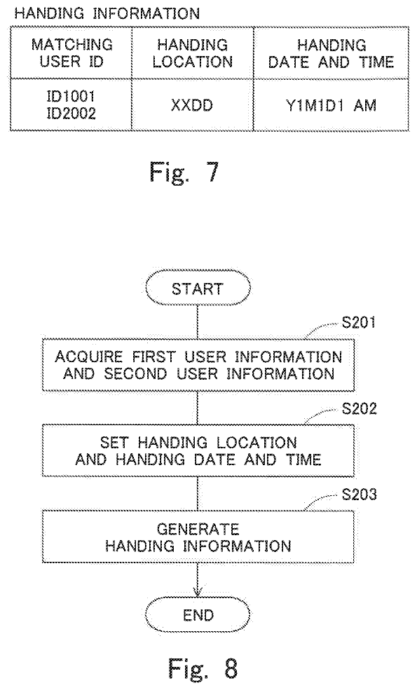

FIG. 7 is a diagram illustrating an example of a table structure of the handing information generated by the setting processing. This handing information table has a matching user ID field, a handing location field, and a handing date and time field.

In the matching user ID field, a first user ID and a second user ID of the first user and the second user between whom matching is achieved in the matching processing by the matching unit 1040 are input. Further, in the handing location field, information regarding the handing location set through the setting processing is input. It is sufficient if the information is information such as, for example, address information, from which the handing location can be specified. Further, in the handing date and time field, information regarding the handing date and time set through the setting processing is input. It is sufficient if the information is information from which the handing date and time can be specified.

Then, in the present embodiment, the providing unit 1041 provides the handing information to the first user and the second user between whom matching is achieved through the matching processing. Specifically, the providing unit 1041 transmits the handing information generated at the setting unit 1042 to the first user terminal 10 of the first user and the second user terminal 20 of the second user via the communication unit 101 along with the matching information generated at the matching unit 1040.

(Setting Processing)

Here, details of the setting processing performed at the setting unit 1042 of the control unit 104 will be described on the basis of the flowchart illustrated in FIG. 8. Note that this setting processing is executed in the case where matching is achieved between the first user and the second user (that is, in the case where the processing in S103 is executed in flow of the matching processing illustrated in FIG. 5) in the matching processing at the matching unit 1040.

In the present flow, first, in S201, the first user information and the second user information for the first user and the second user between whom matching is achieved in the matching processing are acquired. Then, in S202, the handing location and the handing date and time are set on the basis of the first user information and the second user information acquired in S201.

Here, for example, in the case where the home location of the second user in the second user information exists on the traveling route of the first user derived on the basis of the information regarding the home location and the information regarding the traveling destination in the first user information, the home location of the second user may be set as the handing location. Further, in this case, the handing date and time may be set on the basis of an expected traveling period from the home location of the first user to the home location of the second user when the first user travels on the derived traveling route by the vehicle V, and the traveling date and time of the first user included in the first user information.

Further, it is also possible to register information indicating that the first user has an intention of stopping at the home of the second user with whom matching is achieved when the first user travels to the traveling destination by the vehicle V, in the first DB 102 as one of the first user information. Then, in the case where the information is included in the first user information, the home location of the second user may be set as the handing location. Further, it is also possible to register information indicating that the second user has an intention of visiting the home of the first user with whom matching is achieved to hand the golf bag G, in the second DB 103 as one of the second user information. Then, in the case where the information is included in the second user information, the home location of the first user may be set as the handing location.

Further, the management server 100 may include a candidate location database in which a plurality of candidate locations which can be the handing location are stored. In this case, an optimal handing location may be selected from candidate locations stored in the candidate location database.

If the handing location and the handing date and time are set in S202, then, in S203, the handing information is generated on the basis of the handing location and the handing date and time.

As described above, in the present embodiment, to the first user and the second user between whom matching is achieved, the handing information regarding the handing location and the handing date and time for handing the golf bag G is provided from the management server 100. Therefore, it is possible to improve user-friendliness for handing of the golf bag G from the second user to the first user.

### Other Embodiments

The above-described embodiments are merely an example, and the present disclosure can be changed and implemented as appropriate without departing from the scope of the disclosure. Here, in the above-described first embodiment and second embodiment, the first user is set as a user who plans to travel to a golf course by a vehicle, and the second user is set as a user who desires to deliver a golf bag to the golf course. However, the present disclosure can be applied to a matching system for performing matching between a first user and a second user who are different from such users.

For example, the present disclosure may be applied to a matching system for performing matching between the first user and the second user in which a user who plans to travel to an airport or accommodation by a vehicle is set as the first user, and a user who desires to deliver baggage for traveling such as a suit case to the airport or the accommodation is set as the second user. In this case, the airport and the accommodation become the “traveling destination” and the “delivery destination”.

Further, the processing and the means described in the present disclosure can be freely combined and implemented unless technical inconsistency occurs.

Further, the processing described as being performed by one apparatus may be shared and executed by a plurality of apparatuses. Alternatively, the processing described as being performed by different apparatuses may be executed by one apparatus. In a computer system, it is possible to flexibly change a hardware configuration (server configuration) which implements each function.

The present disclosure can also be implemented by computer programs which implement the functions described in the above-described embodiments being supplied to a computer, and one or more processors of the computer reading out and executing the programs. Such computer programs may be provided to the computer by a non-transitory computer readable storage medium which can be connected to a system bus of the computer or may be provided to the computer via a network. The non-transitory computer readable storage medium includes, for example, an arbitrary type of disk such as a magnetic disk (such as a floppy (registered trademark) disk and a hard disk drive (HDD)) and an optical disk (such as a CD-ROM, a DVD disk and a Blu-ray disk), a read only memory (ROM), a random access memory (RAM), an EPROM, an EEPROM, a magnetic card, a flash memory, an optical card, and an arbitrary type of medium appropriate for storing electronic commands.

What is claimed is:

1. An information processing apparatus comprising a controller that, based on first user information which is information regarding traveling by a vehicle of a first user who plans to travel to a traveling destination by the vehicle and second user information which is information regarding delivery of baggage of a second user who desires to deliver the baggage to a delivery destination, performs matching between the first user and the second user in a case where it is determined that a predetermined condition is satisfied, the predetermined condition being a condition that the baggage of the second user can be delivered to the delivery destination by the vehicle when the first user travels to the traveling destination.

2. The information processing apparatus according to claim 1,
wherein the first user information includes information regarding the traveling destination, information regarding a starting point of traveling by the vehicle, information regarding scheduled traveling time and information regarding empty space in predetermined space in which baggage is to be loaded in the vehicle, and
the second user information includes information regarding the delivery destination, information regarding a starting point of delivery of the baggage, information regarding desired delivery time and information regarding a volume of the baggage.

3. The information processing apparatus according to claim 2,
wherein the predetermined condition includes a condition that a volume of the baggage of the second user is equal to or less than a volume of the empty space in the predetermined space in which baggage is to be loaded in the vehicle of the first user.

4. The information processing apparatus according to claim 2,
wherein the predetermined condition further includes a condition that the traveling destination of the first user is the same as the delivery destination of the second user, and a condition that the starting point of traveling by the vehicle of the first user and the starting point of delivery of the baggage of the second user are located within a predetermined range.

5. The information processing apparatus according to claim 2,
wherein the predetermined condition further includes a condition that the starting point of delivery of the baggage and the delivery destination of the second user exist on a traveling route from the starting point of traveling by the vehicle to the traveling destination of the first user.

6. The information processing apparatus according to claim 2,
wherein the predetermined condition includes a condition that the scheduled traveling time of the first user is the same as the desired delivery time of the second user.

7. The information processing apparatus according to claim 2,
wherein the predetermined condition includes a condition that the scheduled traveling time of the first user is the same as or before the desired delivery time of the second user.

8. The information processing apparatus according to claim 1,
wherein the controller further sets a location and time for handing the baggage between the first user and the second user between whom matching is achieved based on the first user information and the second user information, and provides handing information which is information regarding the location and the time for handing the baggage to the first user and the second user between whom matching is achieved.

9. An information processing method comprising:
a step of acquiring first user information which is information regarding traveling by a vehicle of a first user who plans to travel to a traveling destination by the vehicle, and second user information which is information regarding delivery of baggage of a second user who desires to deliver the baggage to a delivery destination;
a step of determining based on the first user information and the second user information whether or not a predetermined condition is satisfied, the predetermined condition being a condition that the baggage of the second user can be delivered to the delivery destination by the vehicle when the first user travels to the traveling destination; and
a step of performing matching between the first user and the second user in a case where it is determined that the predetermined condition is satisfied.

10. A non-transitory storage medium stored with a program for causing a computer to execute the information processing method, wherein the information processing method comprising:
a step of acquiring first user information which is information regarding traveling by a vehicle of a first user who plans to travel to a traveling destination by the vehicle, and second user information which is information regarding delivery of baggage of a second user who desires to deliver the baggage to a delivery destination;
a step of determining based on the first user information and the second user information whether or not a predetermined condition is satisfied, the predetermined condition being a condition that the baggage of the second user can be delivered to the delivery destination by the vehicle when the first user travels to the traveling destination; and
a step of performing matching between the first user and the second user in a case where it is determined that the predetermined condition is satisfied.
